(19) United States
(12) Patent Application Publication
(10) Pub. No.: US 2009/0012751 A1
(43) Pub. Date: Jan. 8, 2009

(54) METHOD AND PROGRAM FOR STRUCTURE ANALYSIS BY FINITE ELEMENT METHOD

(75) Inventor: Mikio Kurita, Aichi (JP)

Correspondence Address: SUGHRUE MION, PLLC, 2100 PENNSYLVANIA AVENUE, N.W., SUITE 800, WASHINGTON, DC, 20037, US

(73) Assignee: National University Corporation Nagoya University, Nagoya-shi, Aichi (JP)

(21) Appl. No.: 12/162,178

(22) PCT Filed: Dec. 1, 2006
(86) PCT No.: PCT/JP2006/324105

§ 371 Date: Jul. 25, 2008

(30) Foreign Application Priority Data
Jan. 27, 2006 (JP) 2006-019255

(51) Int. Cl. G06F 17/50; G06F 17/10

(52) U.S. Cl. 703/1; 703/2

(57) ABSTRACT

In a structure analysis method by the finite element method, based on a characteristic that when a load is applied to a structure, an arbitrary point of the structure describes an ellipsoidal shape in accordance with a direction of the load, an equation of the ellipsoidal shape formed by the arbitrary point of the structure when being displaced is formulated based on a constraint condition, a load condition and a stiffness matrix for the structure; and a displacement of the arbitrary point when an arbitrary load is applied to the structure is obtained based on the formulated equation of the ellipsoidal shape.

### TECHNICAL FIELD

The present invention relates to a method and a program for structure analysis by the finite element method.

### BACKGROUND ART

In the conventional analysis of the strength of a structure having a complex configuration or the like, analysis by performing the finite element method (FEM: Finite Element Method) using a computer is often employed. In the finite element method, a configuration of a structure to be analyzed is divided into small polygonal or polyhedral sections, each called an “element” (also called a “mesh”), and models equivalent to the respective divided small sections are created. By formulating an equation of an entire structure based on the models, a physical quantity of a displacement or the like of the structure to be analyzed, is calculated and analyzed. This is the most popular numerical analysis method.

In the finite element method employed for structure analysis, a result is obtained by solving a stiffness matrix having information of a structure and a matrix indicating a constraint condition (a boundary condition) and a load, i.e., by solving a stiffness equation. Accordingly, creation and calculation of a matrix are performed regarding each load condition and each constraint condition.

In a mechanical analysis of a three-dimensional model, a constraint condition and a point of application of a load are usually constant, and focus is placed in most cases on an amount of deformation for each different direction of the load. Also, whether or not the model can maintain the function is considered usually based on whether or not a deformation of a specific portion in the model exceeds an acceptable value rather than on a deformation of the entire model. Accordingly, calculation is repeated in the analysis of the model while changing the direction of the load, that is, for each load condition (for example, see Patent Document 1).
Patent Document 1: Japanese Unexamined Patent Application Publication No. 2004-54863

### DISCLOSURE OF THE INVENTION

### Problems to be Solved by the Invention

However, several types of conditions and enormous information are required to solve the stiffness equation by the repeated calculations, and a significant time period is required to perform matrix calculation of generally several tens of thousands of rows by several tens of thousands of columns. That is, the conventional finite element method requires an enormous amount of time for an analysis work since it is necessary to repeat calculation for each analysis condition.

Also, a quantitative analysis is always performed in the finite element method, which is a numerical analysis. That is, efficiency in calculation time cannot be improved since it is necessary to perform calculation for each load condition.

The present invention, which has been made in view of the above problems, has an object to provide a method for structure analysis by the finite element method that allows reduction of calculation time in a case of different magnitude and direction in the load condition.

### Means to Solve the Problems

For clearer understanding of the present invention, the creation process of the technical thought of the present invention will now be explained before providing a specific explanation of the means to solve the problems recited in claims.

In a structure analysis or the like, analysis should be performed by variously changing analysis conditions, such as a magnitude and a direction of a load. When the finite element method is employed for the analysis, it is necessary to solve a stiffness equation each time one of the analysis conditions are changed, which requires a massive amount of calculations.

The inventor of the present invention, however, has found that a set of displacements of an arbitrary point constitutes an ellipsoid when a constant magnitude of force is applied to a structure, and the shape of the ellipsoid depends on a position of a measurement point, a position of point of application of the force and a constraint condition. That is, a displacement of an arbitrary structure may be represented not in a complex manner but by vectors in three directions even if an arbitrary constraint condition is employed.

In short, when a constant force is applied, an arbitrary point of a structure is moved (displaced) while describing an ellipsoidal shape in accordance with a direction of the force. Hereinafter, an ellipsoid formed as above is referred to as a “displacement ellipsoid”.

Characteristics of the displacement ellipsoid are applied to the finite element method, and thereby an analysis method, which does not require solving a stiffness equation each time the analysis conditions are changed, has been invented. The analysis method will be explained below.

In the finite element method, a structure is divided into a plurality of elements, which are regarded as respective springs, and a stiffness equation is created by regarding the structure as a set of the springs. A load applied to the structure is represented by stresses and strains in the respective elements, and thereby a displacement of the entire structure is derived. The reverse process is conceivable.

FIGS. 5(a), 5(b) and 5(c) show examples of dividing a structure 30 into a plurality of elements. FIG. 5(a) shows an outer shape of the structure 30. FIG. 5(b) shows a case of dividing the structure 30 into four elements, and FIG. 5(c) shows a case of dividing the structure 30 into sixteen elements.

To generalize cases of dividing a structure into a plurality of elements as shown in FIGS. 5(a), 5(b) and 5(c), it is provided that the structure is divided into a number of k elements and a number of m nodes. As seen from FIGS. 5(a), 5(b) and 5(c), positions and the number of nodes are determined depending on how the division into elements is performed. A shape of each element is represented by coordinates of the nodes of the element, and a stiffness between neighboring nodes is determined by the shape of the element and properties of the material of the element. Accordingly, a structure constituted by the number of m nodes having degrees of freedom of 3 m, and the stiffness equation is represented by an equation 1.

$$( \begin{matrix}{f}_{1 x} \\ {f}_{1 y} \\ ⋮ \\ ⋮ \\ ⋮ \\ {f}_{mz}\end{matrix} ) = ( \begin{matrix}{k}_{11} & {k}_{12} & … & … & … & {k}_{13 m} \\ {k}_{21} & {k}_{22} & … & … & … & {k}_{23} \\ ⋮ & ⋮ & & & & \\ ⋮ & ⋮ & & & & \\ ⋮ & ⋮ & & & & \\ {k}_{3 m 1} & {k}_{3 m 2} & … & … & … & {k}_{3 m 3 m}\end{matrix} ) ( \begin{matrix}{u}_{1 x} \\ {u}_{1 y} \\ ⋮ \\ ⋮ \\ ⋮ \\ {u}_{mz}\end{matrix} ) \qquad ( Equation 1 )$$

The left side is a matrix of 1×3 m of forces applied to the respective nodes. The right side is a stiffness matrix K(kᵢⱼ) of 3 m×3 m and a matrix representing displacements of 1×3 m. When a coordinate system is plotted as (x, y, z) in a Cartesian coordinate, the positions and the number of nodes are changed depending on how division into elements is performed, and thus the stiffness matrix will be changed.

However, when the division is performed in a sufficiently minute manner, differences in results of the obtained displacements and the stress distribution may be ignored even if the stiffness matrix is changed. The stiffness matrix is inherently always a symmetrical matrix (kᵢⱼ=kⱼᵢ) since spring coefficients are the same although directions of the forces are opposite between the respective nodes.

Matrix elements of a load are “0” except at a node to which the load is applied and constrained nodes. When a self weight is applied, forces in the same direction are applied to all the nodes. Matrix elements of a displacement are “0” at constrained nodes.

It is provided that a force represented by the following equation 2 is applied to the n-th node of the structure, and that the s-th node is constrained.

\vec{F}ₙ=\vec{f}ₙₓ+\vec{f}_{ny}+\vec{f}_{nz} (Equation 2)

It is provided that translation and rotation of the structure as a rigid body are constrained due to the constraint of the s-th node, and the stiffness matrix has an inverse matrix. A reaction from the constrained point s is represented by the following equation 3.

\vec{f}ₛₓ,\vec{f}_{sy},\vec{f}_{sz} (Equation 3)

The reaction necessarily is a function (unknown) of the force applied to the n-th node. The stiffness equation is represented by the following equation 4.

$$( \begin{matrix}0 \\ ⋮ \\ {f}_{nx} \\ {f}_{ny} \\ {f}_{nz} \\ ⋮ \\ {f}_{sx} \\ {f}_{sy} \\ {f}_{sz} \\ ⋮ \\ 0\end{matrix} ) = ( \begin{matrix}{k}_{11} & … & {k}_{13 n - 2} & {k}_{13 n - 1} & {k}_{13 n} & … & {k}_{13 s - 2} & {k}_{13 s - 1} & {k}_{13 s} & … & {k}_{13 m} \\ ⋮ & ⋱ & ⋮ & ⋮ & ⋮ & ⋮ & ⋮ & ⋮ & ⋮ & ⋰ & ⋮ \\ {k}_{3 n - 21} & … & & & & & & & & & \\ {k}_{3 n - 11} & … & & & & & & & & & \\ {k}_{3 n 1} & … & & & & & & & & & \\ ⋮ & … & & & & & & & & & \\ {k}_{3 s - 21} & … & & & & & & & & & \\ {k}_{3 s - 11} & … & & & & & & & & & \\ {k}_{3 s 1} & … & & & & & & & & & \\ ⋮ & ⋰ & & & & & & & & ⋱ & ⋮ \\ {k}_{3 m 1} & … & & & & & & & & … & {k}_{3 m 3 m}\end{matrix} ) ( \begin{matrix}{u}_{1 x} \\ ⋮ \\ {u}_{nx} \\ {u}_{ny} \\ {u}_{nz} \\ ⋮ \\ 0 \\ 0 \\ 0 \\ ⋮ \\ {u}_{mz}\end{matrix} ) \qquad ( Equation 4 )$$

This equation is expanded. In view of the “0” component at the constrained point, this equation can be divided into two matrix calculations, as represented by the following equations 5a and 5b.

$$\begin{matrix}( \begin{matrix}0 \\ ⋮ \\ {f}_{nz} \\ ⋮ \\ {f}_{s - 1 z} \\ {f}_{s + 1 x} \\ ⋮ \\ 0\end{matrix} ) = ( \begin{matrix}{k}_{11} & … & {k}_{13 n - 3} & {k}_{13 n + 1} & … & {k}_{13 m} \\ ⋮ & & ⋮ & ⋮ & & ⋮ \\ {k}_{3 n 1} & ⋱ & {k}_{3 n 3 n - 3} & {k}_{3 n 3 n + 1} & ⋱ & {k}_{3 n 3 m} \\ ⋮ & & ⋮ & ⋮ & & ⋮ \\ {k}_{3 s - 31} & … & {k}_{3 s - 33 n - 3} & {k}_{3 s - 33 n + 1} & … & {k}_{3 s - 33 m} \\ {k}_{3 s + 11} & … & {k}_{3 s + 13 n - 3} & {k}_{3 s + 13 n + 1} & … & {k}_{3 s + 13 m} \\ ⋮ & ⋱ & ⋮ & ⋮ & ⋱ & ⋮ \\ {k}_{3 m 1} & … & {k}_{3 m 3 n - 3} & {k}_{3 m 3 n + 1} & … & {k}_{3 m 3 m}\end{matrix} ) ( \begin{matrix}{u}_{1 x} \\ ⋮ \\ {u}_{nz} \\ ⋮ \\ {u}_{s - 1 z} \\ {u}_{s + 1 x} \\ ⋮ \\ {u}_{mz}\end{matrix} ) & ( Equation 5 a ) \\ ( \begin{matrix}{f}_{sx} \\ {f}_{sy} \\ {f}_{sz}\end{matrix} ) = ( \begin{matrix}{k}_{3 s - 21} & … & {k}_{3 s - 23 n - 3} & {k}_{3 s - 23 n + 1} & … & {k}_{3 s - 23 m} \\ {k}_{3 s - 11} & … & {k}_{3 s - 13 n - 3} & {k}_{3 s - 13 n + 1} & … & {k}_{3 s - 13 m} \\ {k}_{3 s 1} & … & {k}_{3 s 3 n - 3} & {k}_{3 s 3 n + 1} & … & {k}_{3 s 3 m}\end{matrix} ) ( \begin{matrix}{u}_{1 x} \\ ⋮ \\ {u}_{nx} \\ {u}_{ny} \\ {u}_{nz} \\ ⋮ \\ {u}_{mz}\end{matrix} ) & ( Equation 5 b )\end{matrix}$$

The stiffness matrix of the equation 5a is referred to as K′, and the stiffness matrix of the equation 5b is referred to as Kₛ. The stiffness matrix K′, which is a matrix of 3 m−3×3 m−3 obtained by subtracting three degrees of freedom at the constrained point from rows and columns of a matrix K of 3 m×3 m, is a square matrix and may have an inverse matrix. That is, since there is a one-to-one relationship between a displacement and a force when the force is applied to an object whose translation and rotation as a rigid body is constrained, the stiffness matrix K′ may have an inverse matrix.

When an inverse matrix of the stiffness matrix K′ is referred to as G′ (gᵢⱼ), the equation 5a can be rewritten as the following equation 6.

$$( \begin{matrix}{u}_{1 x} \\ ⋮ \\ {u}_{nx} \\ {u}_{ny} \\ {u}_{nz} \\ ⋮ \\ {u}_{mz}\end{matrix} ) = \frac{1}{det {K}^{′}} ( \begin{matrix}{g}_{11}^{′} & … & … & … & … & {g}_{13 m - 3}^{′} \\ ⋮ & ⋮ & ⋮ & ⋮ & ⋮ & ⋮ \\ ⋮ & … & … & … & … & ⋮ \\ ⋮ & … & … & … & … & ⋮ \\ ⋮ & … & … & … & … & ⋮ \\ ⋮ & ⋮ & ⋮ & ⋮ & ⋮ & ⋮ \\ {g}_{3 m - 31}^{′} & … & … & … & … & {g}_{3 m - 33 m - 3}^{′}\end{matrix} ) ( \begin{matrix}0 \\ ⋮ \\ {f}_{nx} \\ {f}_{ny} \\ {f}_{nz} \\ ⋮ \\ 0\end{matrix} ) \qquad ( Equation 6 )$$

When this matrix is expanded, parts other than parts regarding fₙ are erased, and thus this equation 6 may be rewritten as the following equation 7.

$$( \begin{matrix}{u}_{1 x} \\ ⋮ \\ {u}_{nx} \\ {u}_{ny} \\ {u}_{nz} \\ ⋮ \\ {u}_{mz}\end{matrix} ) = \frac{1}{det {K}^{′}} ( \begin{matrix}{g}_{13 n - 2}^{′} & {g}_{13 n - 1}^{′} & {g}_{13 n}^{′} \\ ⋮ & ⋮ & ⋮ \\ ⋮ & ⋮ & ⋮ \\ ⋮ & ⋮ & ⋮ \\ ⋮ & ⋮ & ⋮ \\ ⋮ & ⋮ & ⋮ \\ {g}_{3 m - 33 n - 2}^{′} & {g}_{3 m - 33 n - 1}^{′} & {g}_{3 m - 33 n}^{′}\end{matrix} ) ( \begin{matrix}{f}_{nx} \\ {f}_{ny} \\ {f}_{nz}\end{matrix} ) \qquad ( Equation 7 )$$

When an arbitrary i-th element is focused on and is expressed using a matrix, a square matrix of 3×3 as represented by the following equation 8 is obtained.

$$( \begin{matrix}{u}_{ix} \\ {u}_{iy} \\ {u}_{iz}\end{matrix} ) = \frac{1}{det {K}^{′}} ( \begin{matrix}{g}_{3 i - 23 n - 2} & {g}_{3 i - 23 n - 1} & {g}_{3 i - 23 n} \\ {g}_{3 i - 113 n - 2} & {g}_{3 i - 13 n - 1} & {g}_{3 i - 13 n} \\ {g}_{3 i 3 n - 2} & {g}_{3 i 3 n - 1} & {g}_{3 i 3 n}\end{matrix} ) ( \begin{matrix}{f}_{nx} \\ {f}_{ny} \\ {f}_{nz}\end{matrix} ) \qquad ( Equation 8 )$$

Now, an inverse matrix P(P₁ₘ) of this matrix G is applied to both sides. Although the inverse matrix is inherently determined by the stiffness matrix K, the inverse matrix may be represented by the following equation 9 after replacing sequential suffixes of 1 and m to avoid complication.

$$( \begin{matrix}{f}_{nx} \\ {f}_{ny} \\ {f}_{nz}\end{matrix} ) = \frac{det {K}^{′}}{det {G}^{′}} ( \begin{matrix}{p}_{11} & {p}_{12} & {p}_{13} \\ {p}_{21} & {p}_{22} & {p}_{23} \\ {p}_{31} & {p}_{32} & {p}_{33}\end{matrix} ) ( \begin{matrix}{u}_{ix} \\ {u}_{iy} \\ {u}_{iz}\end{matrix} ) \qquad ( Equation 9 )$$

This indicates the load by the displacements.

It is provided that a magnitude of the load:

|\vec{F}ₙ|

is constant. The constant load is substituted to the following equation 10.

fₙₓ²+f_{ny}²+f_{nz}²=Fₙ² (Equation 10)

Then, the equation 9 is represented as the following equation 11.

$$( {p}_{11}^{2} + {p}_{12}^{2} + {p}_{13}^{2} ) {u}_{ix}^{2} + ( {p}_{21}^{2} + {p}_{22}^{2} ; {p}_{23}^{2} ) {u}_{1 ix}^{2} + ( {p}_{31}^{2} + {p}_{32}^{2} + {p}_{33}^{2} ) {u}_{iz}^{2} + 2 ( {p}_{11} {p}_{21} + {p}_{12} {p}_{22} + {p}_{13} {p}_{23} ) {u}_{ix} {u}_{iy} + 2 ( {p}_{21} {p}_{31} + {p}_{22} {p}_{32} + {p}_{23} {p}_{33} ) {u}_{iy} {u}_{iz} + 2 ( {p}_{31} {p}_{11} + {p}_{32} {p}_{12} + {p}_{33} {p}_{13} ) {u}_{iz} {u}_{1 ix} = {( {F}_{n} \frac{det {G}^{′}}{det {K}^{′}} )}^{2} \qquad ( Equatio n 11 )$$

This equation expresses an ellipsoid (surface). Specifically, a trajectory described by an arbitrary node (uᵢₓ, u_{iy}, u_{iz}) due to a constant magnitude of load is a surface of a three-axis ellipsoid with its center at an origin. The origin here means a position where the load is “0”. A length of the main axis of the ellipsoid is proportional to a magnitude of a force. Generally, three axes of the ellipsoid do not coincide with axes of the coordinate system. That is, a direction of the load does not coincide with a direction of displacement.

The above explanation is provided regarding a trajectory described by an arbitrary node when a load is applied to an arbitrary node and an arbitrary node is constrained. Generally, there are various constraint conditions and load application methods with respect to a structure. Accordingly, it will now be explained that a displacement ellipsoid can be obtained even when the numbers of constrained points and points of application of load are increased.

When the number of constrained points is increased, the tetragonality of the stiffness matrix (the equation 5a) after the matrix K is expanded and divided into two matrixes is maintained. Accordingly, an inverse matrix is present. The ultimately obtained matrix P is a matrix of 3×3, and the stiffness equation can be solved in a same manner as above. Thus, a displacement ellipsoid may be obtained in a case where multiple constrained points are provided. The displacement ellipsoid has a shape depending on positions of the constrained points.

It is provided that a force represented by the following equation 12 is applied to a node n′ which is different from the node n.

\vec{F}_{n′}=A_{n′}\vec{F}ₙ (Equation 12)

In the equation, A_{n′} is a scalar quantity. In this case, each component of uᵢ is obtained as a sum of values obtained by multiplying each matrix element of fₙ by A_{n′} based on the matrix G′. Accordingly, a displacement of an arbitrary point describes an ellipsoid, which has a shape depending on a magnitude of the force, and the number and positions of applications of the force.

Thus, when same magnitudes of forces are applied to an arbitrary structure from various directions, displacements of any point of the structure is distributed on a surface of an ellipsoid. This image is shown in FIG. 6.

As explained above, when a constant magnitude of force is applied to a structure, a set of displacements of an arbitrary point of the structure constitutes an ellipsoid. The ellipsoid has a shape depending on a position of a measurement point, a position of a point of application of the force and a constraint condition.

Therefore, there has been made the present invention, in which structure analysis is performed by applying the fact that a set of displacements of an arbitrary point of a structure constitutes an ellipsoid when a constant magnitude of force is applied to the structure to the finite element method.

As recited in claim 1, the present invention provides a structure analysis method by the finite element method, wherein, based on a characteristic that when a load is applied to a structure, an arbitrary point of the structure describes an ellipsoidal shape in accordance with a direction of the load, an equation of the ellipsoidal shape formed by the arbitrary point of the structure when being displaced is formulated based on a constraint condition, a load condition and a stiffness matrix for the structure; and a displacement of the arbitrary point when an arbitrary load is applied to the structure is obtained based on the formulated equation of the ellipsoidal shape.

According to the present invention, as explained above, it may be possible to obtain a displacement of an arbitrary point of a structure when a load is applied to the structure based on a formulated equation of an ellipsoidal shape. Thus, even when the load is changed in the structure analysis of the structure by the finite element method, it is unnecessary to solve a stiffness equation in accordance with the change of the load.

That is, it is unnecessary to perform massive matrix calculations each time the load is changed, and it is possible to obtain a displacement of the structure by inserting the load condition into the simple equation of the ellipsoidal shape and solving the equation. Accordingly, a calculation time required for the structure analysis by the finite element method may be reduced.

The “constraint condition” here means a constraint condition within which a displacement ellipsoid can be applied for one analysis result. Specifically, the number of constrained nodes, positions and directions of the respective nodes of the elements are specified as the condition. A change of the condition requires a new analysis to be performed.

The “load condition” here means a load condition within which a displacement ellipsoid can be applied for one analysis result. The number of nodes to which a load is applied and positions of the respective nodes of the elements are specified, and a magnitude and a direction of the load are arbitrary. If the magnitude of the load is constant, the displacement ellipsoid can be applied, while the magnitude and the direction are specified, a displacement caused by the condition can be obtained based on the displacement ellipsoid. Other changes in the load condition require a new analysis to be performed.

It is convenient, in order to perform a structure analysis, that the structure analysis method by the finite element method includes a processing of dividing a structure to be analyzed into meshes and a processing of solving a stiffness equation.

Accordingly, it is preferable that structure analysis of a structure is performed as recited in claim 2 in the structure analysis method by the finite element method according to claim 1. Specifically, structure analysis of a structure is performed by: a mesh creating step of dividing a structure to be analyzed into a plurality of meshes, each including a plurality of nodes; an analysis condition input step of inputting a constraint condition, a load condition and material properties of the structure; a stiffness matrix creation step of creating a stiffness matrix based on the created meshes, the inputted constraint condition and the inputted material properties; an ellipsoidal shape formulation step of solving a stiffness equation based on the inputted constraint condition and load condition and on the created stiffness matrix, obtaining displacements of all nodes for the load condition, and formulating equations of ellipsoidal shapes formed by the respective nodes based on the obtained displacements; and a displacement calculation step of obtaining displacements of the respective nodes when an arbitrary load is applied to the structure based on the formulated equations of the ellipsoidal shapes.

Since equations of the ellipsoidal shapes are formulated for the respective nodes, displacements of the respective nodes, and thus a displacement of the structure, when an arbitrary load is applied to the structure are obtained based on the formulated equations of the ellipsoidal shapes, calculation time may be reduced.

The “stiffness matrix” here means a matrix representing characteristics of the stiffness of a structure. Elements of the matrix include information indicating the stiffness (for example, a Young's modulus). The “stiffness equation” means an equation represented by a matrix indicating a constraint condition (a boundary condition) and a load, and the stiffness matrix. The stiffness equation indicates how the structure represented by the stiffness matrix is displaced under a given load condition.

The term “input” includes a case of inputting a value or the like obtained through an input operation by a person who performs analysis (hereinafter, also referred to as a “user”) or a case of reading a value or the like previously set and stored in a storage device or the like.

A program recited in claim 3 is a structure analysis program by the finite element method, wherein the program causes a computer to perform: an ellipsoidal shape formulation step of, based on a characteristic that when a load is applied to a structure, an arbitrary point of the structure describes an ellipsoidal shape in accordance with a direction of the load, formulating an equation of an ellipsoidal shape formed by the arbitrary point of the structure when being displaced based on a constraint condition, a load condition and a stiffness matrix for the structure; and a displacement calculation step of obtaining a displacement of the arbitrary point when an arbitrary load is applied to the structure based on the formulated equation of the ellipsoidal shape.

This program is a program which may provide effects obtained by the structure analysis method by the finite element method according to claim 1.

A program recited in claim 4 is a structure analysis program by the finite element method according to claim 3, wherein the program causes a computer to perform: a mesh creating step of dividing a structure to be analyzed into a plurality of meshes, each including a plurality of nodes; an analysis condition input step of inputting a constraint condition, a load condition and material properties of the structure; and a stiffness matrix creation step of creating a stiffness matrix based on the created meshes, the inputted constraint condition and the inputted material properties. The program further causes the computer to perform the ellipsoidal shape formulation step to solve a stiffness equation based on the inputted constraint condition and load condition and on the created stiffness matrix, obtain displacements of all nodes for the load condition, and formulate equations of ellipsoidal shapes formed by the respective nodes based on the obtained displacements; and the displacement calculation step to obtain displacements of the respective nodes when an arbitrary load is applied to the structure based on the formulated equations of the ellipsoidal shapes.

This program is a program which may provide effects obtained by the structure analysis method by the finite element method according to claim 2.

This program may be a stand-alone program, but may be incorporated into an existing FEM program, for example, NASTRAN, etc.

### BRIEF DESCRIPTION OF THE DRAWINGS

FIGS. 1(a) and 1(b) are flowcharts of structure analysis processes by the finite element method.

FIG. 2 is a diagram showing a truss structure 10 to be analyzed.

FIGS. 3(a) and 3(b) are analysis diagrams showing displacements of a model 20 of the truss structure 10.

FIG. 4 is a diagram showing a displacement of a node C of the model 20.

FIGS. 5(a), 5(b) and 5(c) are diagrams showing examples of dividing a structure 30 into a plurality of elements.

FIG. 6 is diagram showing a trajectory of the node C when a load is applied to the model 20.

### EXPLANATION OF REFERENCE NUMERALS

10 . . . truss structure, 11a, 11b, 11c, 11d . . . node
12a, 12b, 12c, 12d . . . linear member,
13a, 13b . . . base portion, 20 . . . model, 30 . . . structure

### BEST MODE FOR CARRYING OUT THE INVENTION

An embodiment to which the present invention is applied will be explained below with reference to the drawings. Embodiments of the present invention should not be limited to the below explained embodiment, but may be in various forms as long as within the technical scope of the present invention.

In the present embodiment, an explanation is provided about a case of applying the above explained concept of displacement ellipsoid to a truss structure to analyze the truss structure.

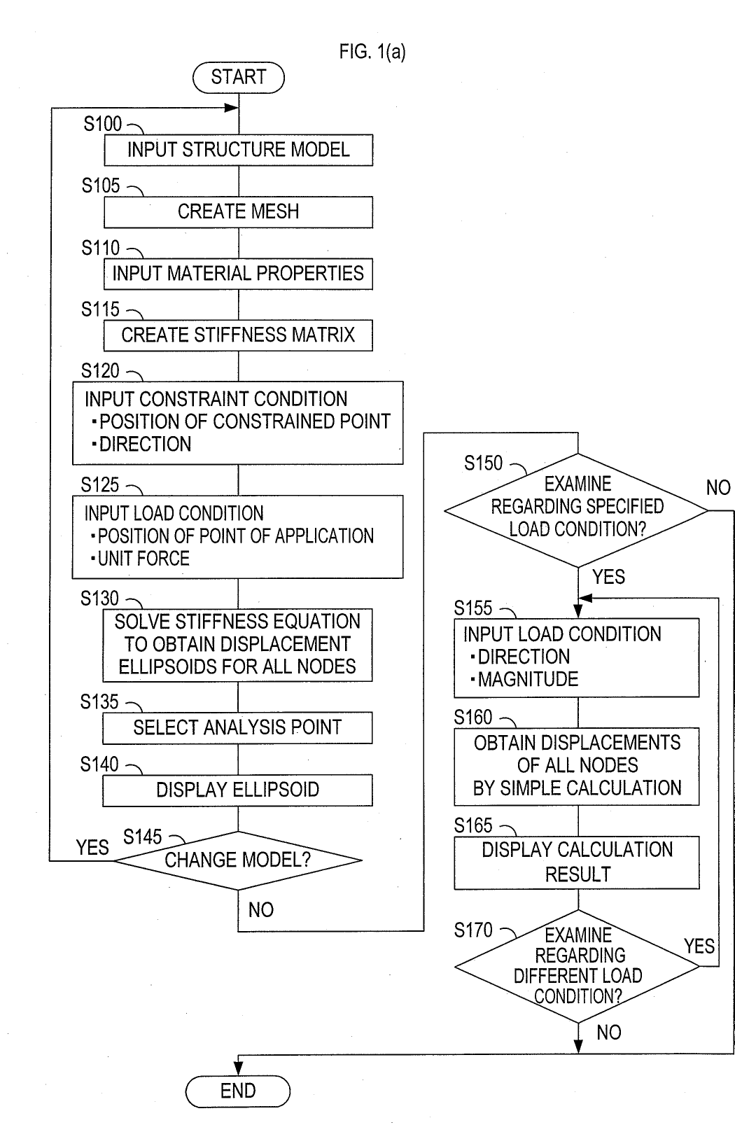

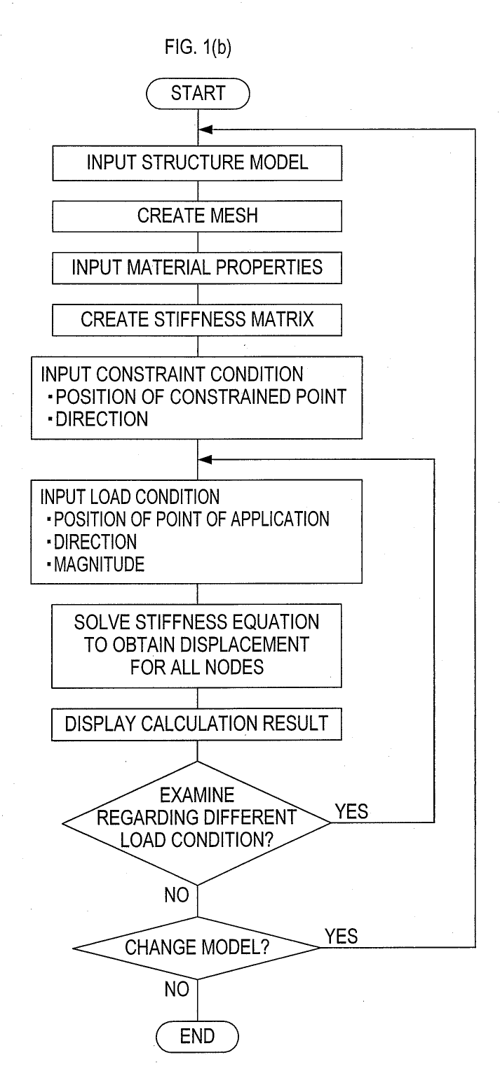

FIGS. 1(a)-(b) are flowcharts of structure analysis processes by the finite element method. A flowchart of a structure analysis process to which the present invention is applied is shown in FIG. 1(a), while a flowchart of a conventional structure analysis process is shown in FIG. 1(b) for comparison purposes.

Since a computer for performing the present process may be any computer which includes a storage device, an input device, a display device, etc. and is capable of performing the structure analysis by the finite element method, an explanation thereof is omitted.

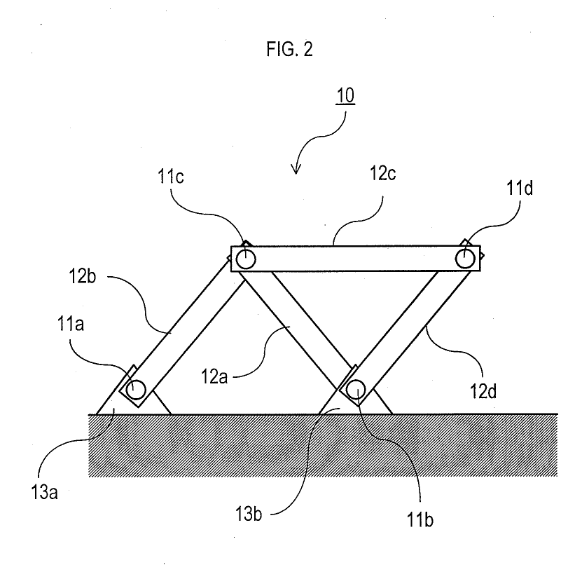

In the structure analysis process shown in FIG. 1(a), first, a model of a structure is inputted in S100. Specifically, in the present embodiment, a configuration of a truss structure 10 constituted by nodes 11a, 11b, 11c and 11d; linear members 12a, 12b, 12c and 12d; and base portions 13a and 13b to which the linear members are fixed, as shown in FIG. 2, is inputted. More specifically, coordinates of the respective nodes 11a-11d and the respective base portions 13a, 13b; and correspondences between the respective nodes 11a-11d and the respective base portions 13a and 13b, and the respective linear members 12a-12d, or the like, are inputted.

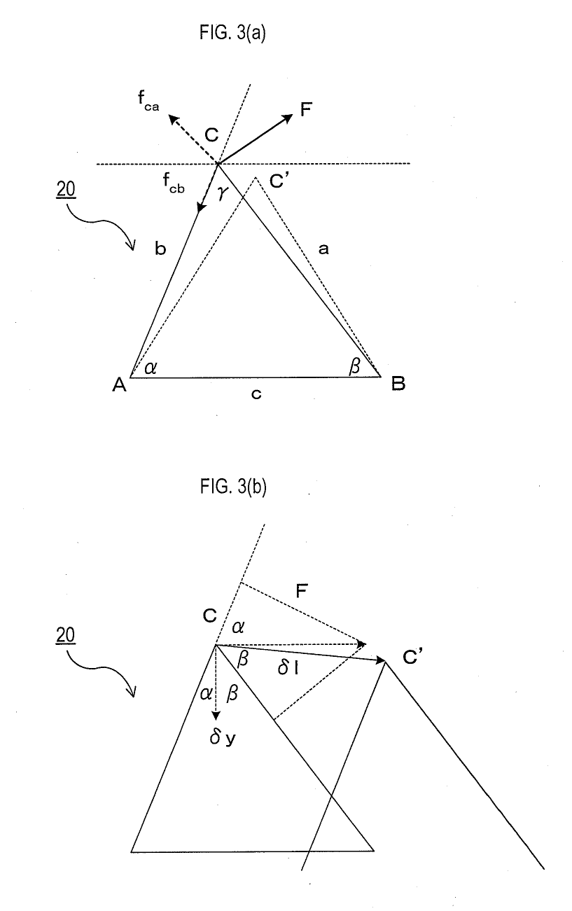

In the present embodiment, in which an amount of deformation of a triangular truss per unit area is calculated, a triangle ABC which is one of triangles constituting the truss structure is inputted as a model 20. The model 20 is a triangle including vertexes of the triangle ABC as respective nodes A, B and C, as shown in FIG. 3(a).

A side c is defined between the nodes A and B, a side a is defined between the nodes B and C, a side b is defined between the nodes C and A, an angle formed by the side b and the side c is defined as an angle α, an angle formed by the side c and the side a is defined as an angle β, and an angle formed by the side a and the side b is defined as an angle β.

Also, a unit force is applied to the node C of the triangle model 20 shown in FIG. 3(a). After inputting the model as explained above, the present process proceeds to S105.

It may be possible to incorporate a known program, such as a program for CAD (Computer Aided Design), into the present process to perform a model input processing, in order to facilitate easy input of a structure having a more complex configuration as a model.

In S105, a mesh including a plurality of nodes is created based on the model inputted in S100. Since mesh creation may be performed using a known method, for example, an adaptive method, a detailed explanation of the mesh creation is omitted. In the present embodiment, the triangle model 20 shown in FIG. 3(a) is the mesh. After the mesh creation, the present process proceeds to S110.

In S110, material properties are inputted. The material properties to be inputted in this step are properties, e.g., a spring constant of the material, and the like, indicating characteristic features of the material of the structure.

In the present embodiment, the linear members constituting the respective sides a, b, and c of the triangle have the same cross sectional area, and a spring constant ES of 1 per unit length of the linear members. Here, S means a cross-sectional area of the linear member, and E means a Young's modulus of the linear member.

After the input of the material properties, the present process proceeds to S115.

In S115, a stiffness matrix is created. Specifically, a load F by unit force is divided into a direction AC and a component perpendicular to the direction AC. An equilibrium among the divided force, a force fca applied on the side b, and a force fcb applied on the linear member a is represented by the following equation 13a and equation 13b.

F sin θ=f_{ca} sin γ (Equation 13a)

F cos θ=f_{cb}−f_{ca} cos λ (Equation 13b)

From the above, the following equation 14a and equation 14b are obtained.

$$\begin{matrix}{f}_{ca} = \frac{F sin θ}{sin γ} & ( Equation 14 a ) \\ {f}_{cb} = F cos θ + F sin θ \frac{1}{tan γ} & ( Equation 14 b )\end{matrix}$$

An amount of extension or contraction δca of the linear member b and an amount of extension or contraction δcb of the linear member c due to the load F are represented by the following equation 15a and equation 15b.

$$\begin{matrix}{δ}_{ca} = a \frac{F sin θ}{sin γ} & ( Equation 15 a ) \\ {δ}_{cb} = b ( F cos θ + \frac{F sin θ}{tan λ} ) & ( Equation 15 b )\end{matrix}$$

δca and δcb are represented using displacements δx and δy of X and Y coordinates as the following equation 16a and equation 16b.

δ_{ca}=δₓ cos α−δ_{y} sin α (Equation 16a)

δ_{cb}=−δₓ cos β−δ_{y} sin β (Equation 16b)

The equation 16a and the equation 16b are converted into a matrix form represented by the following equation 17.

$$\begin{matrix}( \begin{matrix}{δ}_{ca} \\ {δ}_{cb}\end{matrix} ) = ( \begin{matrix}cos α & - sin α \\ - cos β & - sin β\end{matrix} ) ( \begin{matrix}{δ}_{x} \\ {δ}_{y}\end{matrix} ) \\ = ( \begin{matrix}a \frac{sin θ}{sin λ} \\ b ( cos θ + \frac{sin θ}{tan λ} )\end{matrix} )\end{matrix} \qquad ( Equation 17 )$$

Accordingly, a final stiffness equation is represented by the following equation 18.

$$\begin{matrix}( \begin{matrix}{f}_{ca} \\ {f}_{cb}\end{matrix} ) = ( \begin{matrix}\frac{1}{a} & 0 \\ 0 & \frac{1}{b}\end{matrix} ) ( \begin{matrix}{δ}_{ca} \\ {δ}_{cb}\end{matrix} ) \\ = ( \begin{matrix}\frac{1}{a} & 0 \\ 0 & \frac{1}{b}\end{matrix} ) ( \begin{matrix}cos α & - sin α \\ - cos β & - sin β\end{matrix} ) ( \begin{matrix}{δ}_{x} \\ {δ}_{y}\end{matrix} )\end{matrix} \qquad ( Equation 18 )$$

After creating the stiffness matrix as explained above, the present process proceeds to S120.

In S120, a constraint condition is inputted. The constraint condition to be inputted in this step includes, for example, a location of a constrained point of the structure, a direction of constraint, etc. In the present embodiment, the constraint condition is that the node A and the node B are fixed. After inputting the constraint condition, the present process proceeds to S125.

In S125, a load condition is inputted. The load condition to be inputted in this step includes a location of a point of application of a load and a unit force applied to each node. In the present embodiment, the load condition is the unit force F=1 applied to a vertex C (the node C) of the triangle ABC formed by the model 20, as shown in FIG. 3(a). After inputting the load condition, the present process proceeds to S130.

Input of the load condition may be performed by reading a load condition previously stored in the storage device of the computer, or by inputting a load condition through a keyboard operated by a user.

In S130, the stiffness equation is solved to obtain displacement ellipsoids for all nodes. In the present embodiment, a displacement of the node C, that is, an equation of an ellipsoidal shape described by the node C, is obtained as explained below. When a displacement δ1 is divided into a horizontal component δx and a vertical component δy, as shown in FIG. 3(b), amounts of displacements of the respective sides can be represented by the following equation 19 based on the equation 17, the equation 18, etc. since the load F=1.

$$( \begin{matrix}{δ}_{x} \\ {δ}_{y}\end{matrix} ) = - \frac{1}{sin λ} ( \begin{matrix}- \frac{a sin β}{sin λ} + \frac{b sin α}{tan λ} & b cos α \\ \frac{a cos β}{sin γ} + \frac{b cos α}{tan λ} & b cos α\end{matrix} ) ( \begin{matrix}sin θ \\ cos θ\end{matrix} ) \qquad ( Equation 19 )$$

Accordingly, δx and δy can be represented by sine functions as the following equations 20a and 20b.

$$\begin{matrix}{δ}_{x} = - \frac{\sqrt{\begin{matrix}( - \frac{a sin β}{sin λ} + \frac{b sin α}{tan γ} ) + \\ {b}^{2} {sin}^{2} α\end{matrix}}}{sin γ} sin ( θ + {ω}_{1} ) \\ = A sin ( θ + {ω}_{1} ) & ( Equation 20 a ) \\ {δ}_{y} = - \frac{\sqrt{\begin{matrix}( - \frac{a cos β}{sin λ} + \frac{b cos α}{tan γ} ) + \\ {b}^{2} {cos}^{2} α\end{matrix}}}{sin γ} sin ( θ + {ω}_{2} ) \\ = A sin ( θ + {ω}_{2} ) & ( Equation 20 b )\end{matrix}$$

In these equations, A and B are coefficients, and ω₁ and ω₂ are represented by the following equation 21a and equation 21b.

$$\begin{matrix}tan {ω}_{1} = \frac{b sin α}{- \frac{a sin β}{sin γ} + \frac{b sin α}{tan γ}} & ( Equation 21 a ) \\ tan {ω}_{2} = \frac{b cos α}{- \frac{a cos β}{sin γ} + \frac{b cos α}{tan γ}} & ( Equation 21 b )\end{matrix}$$

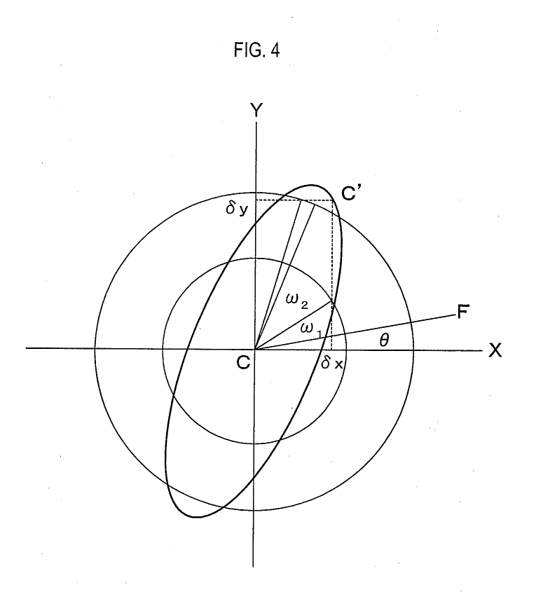

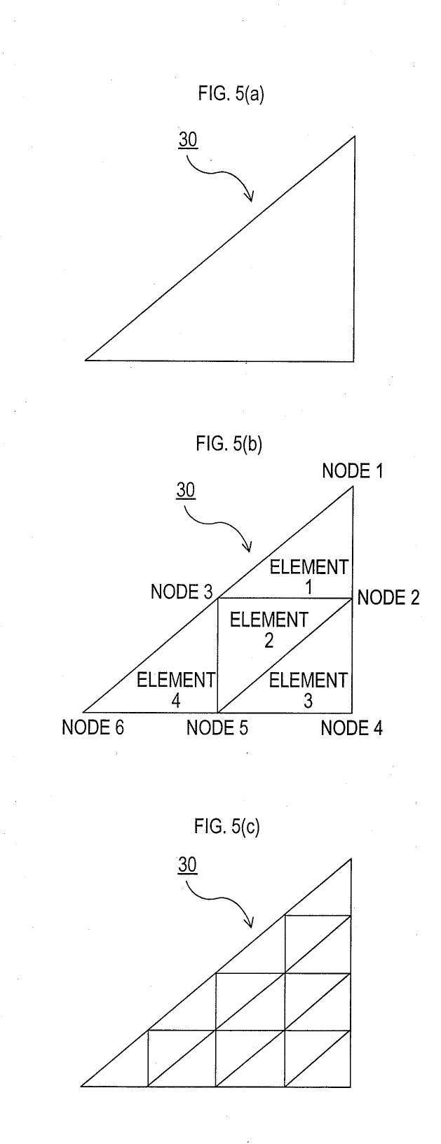

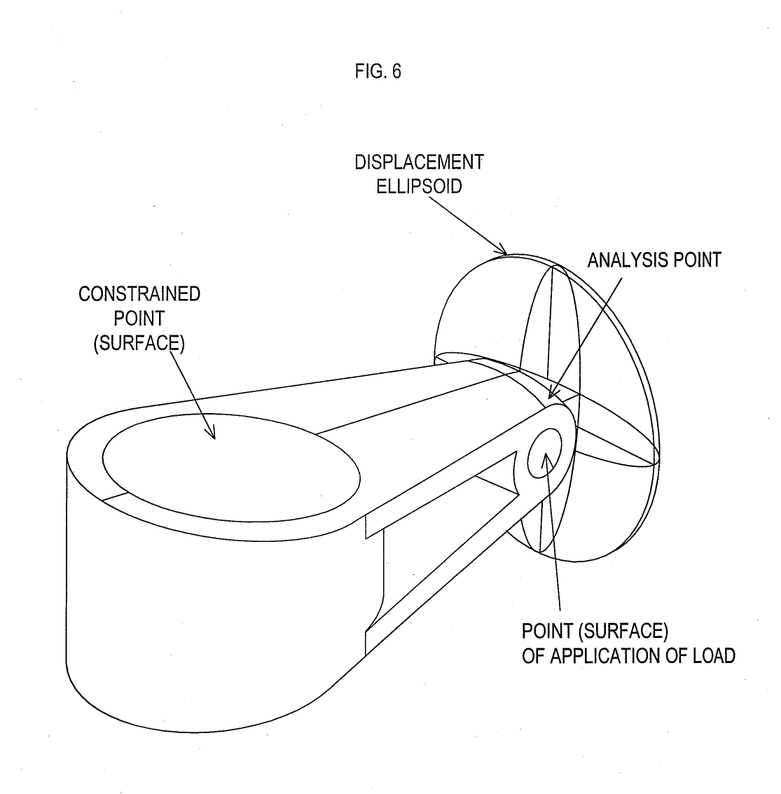

As a result, a trajectory of the node C (and thus a node C′) forms an ellipsoid as shown in FIG. 4. In the present embodiment, it can be seen that a direction of application of the load F and a direction of displacement do not coincide with each other. Also, since a phase difference between the node C and the node C′ is constant, a load causing a maximum displacement and a load causing a minimum displacement are perpendicular to each other.

Particularly, only in a case of a rectangular equilateral triangle, a displacement of the rectangular vertex describes a circular trajectory, and a direction of the displacement and a direction of a load coincide with each other.

Since the nodes a and b are constrained in the present embodiment, the trajectory of only the node C is obtained. However, in a case of a different model including unconstrained nodes, a displacement ellipsoid for each of the unstrained nodes is obtained in a same manner as the case of the node C. After formulating an equation of the ellipsoidal shape described by the node C as explained above, the present process proceeds to S135.

In S135, which analysis point in the displacement ellipsoid obtained in S130 is selected is inputted. In the present embodiment, the node C is selected. After inputting selection of the analysis point, the present process proceeds to S140.

In S140, the ellipsoidal shape described by the analysis point selected in S135, i.e., the node C shown in FIG. 4, is displayed based on a calculation result obtained in S130. The present process proceeds to S145.

In S145, change of model is inputted. An operation of inputting change of model is performed by a user based on the indication of the ellipsoid displayed in S140. Accordingly, in S145, an indication requesting the user to confirm whether or not to input change of model, for example, an indication of “Do you want to input change of model? (Yes/No)”, is displayed on a display.

When the user wants change of model and presses “Y” meaning “Yes” in a keyboard, the “Y” is inputted, while when the user does not want change of model and presses “N” meaning “No” in the keyboard, the “N” is inputted.

When “Y” in the keyboard is pressed, that is, “Yes” is selected in S145, the present process returns to S100 and the same processings are repeated. When “N” in the keyboard is pressed, that is, “No” is selected in S145, the present process proceeds to S150.

In S150, it is determined whether or not to examine with respect to a specified load condition. Specifically, it is determined whether or not instructions to examine with respect to the specified load condition are inputted. When the instructions are inputted (“Yes” in S150), the present process proceeds to S155, while when the instructions are not inputted (“No” in S150), the present process is terminated.

Since a method of inputting whether or not to examine with respect to the specified load condition is the same as an inputting method in S145, an explanation of the method is omitted.

In S155, a load condition is inputted. Specifically, changes of the direction and the magnitude of the load, and the like, are inputted with respect to the load condition inputted in S125. After completing input, the present process proceeds to S160.

Input of the load condition may be performed by reading a load condition previously stored in the storage device of the computer, or by inputting a load condition through a keyboard operated by a user in a same manner as in S125.

In S160, displacements of all the nodes are obtained by simple calculations. Specifically, a displacement of the node C when a different load is applied to the node C is calculated based on the equations 20a and 20b, and the equations 21a and 21b of the ellipsoidal shape formulated in S130.

In S160, it is unnecessary to solve the stiffness equation represented by the equation 18, and the displacement of the node C is obtained by calculating the equations 20a and 20b, and the equations 21a and 21b based on the magnitude of load F (the magnitude for F=1) applied to the node C.

After obtaining the displacements of all the nodes as above, the present process proceeds to S165, and calculation results, i.e., the displacements of all the nodes, are displayed. Then, the present process proceeds to S170.

In S170, it is determined whether or not instructions to examine with respect to a different load condition are inputted. When the instructions are inputted (“Yes” in S170), the present process returns to S155 and the same processings are repeated, while when the instructions are not inputted (“No” in S170), the present process is terminated.

Since a method of inputting whether or not to examine with respect to a different load condition is the same as an inputting method in S145, an explanation of the method is omitted.

In the structure analysis process as explained above, when a load is applied to the truss structure 10, the displacement of the node C of the truss structure 10 can be obtained based on the formulated equations 20a and 20b, and the equations 21a and 21b of the ellipsoidal shape. Accordingly, when the load is changed in the structure analysis of the truss structure 10 by the finite element method, it is unnecessary to solve the stiffness equation represented by the equation 18a in accordance with the change of the load.

That is, in the analysis process shown in FIG. 1(a), it is unnecessary to perform massive matrix calculations each time the load is changed, unlike the conventional analysis process shown in FIG. 1(b), and it is possible to obtain the displacement of the truss structure 10 by inserting the load condition into the simple equations of the ellipsoidal shape and solving the equations. Accordingly, a calculation time required for the structure analysis by the finite element method may be reduced.

Although an embodiment of the present invention has been explained above, the present invention should not be limited to the present embodiment, but may be practiced in various forms.

For example, although the truss structure 10 is the object to be analyzed in the present embodiment, the object to be analyzed may be any other structure that can be analyzed by the finite element method.

Although a triangle mesh is employed in the present embodiment, any other polygonal mesh may be employed.

1. A structure analysis method by the finite element method, wherein, based on a characteristic that when a load is applied to a structure, an arbitrary point of the structure describes an ellipsoidal shape in accordance with a direction of the load, an equation of the ellipsoidal shape formed by the arbitrary point of the structure when being displaced is formulated based on a constraint condition, a load condition and a stiffness matrix for the structure; and a displacement of the arbitrary point when an arbitrary load is applied to the structure is obtained based on the formulated equation of the ellipsoidal shape.

2. The structure analysis method by the finite element method according to claim 1, wherein structure analysis of a structure is performed by:
a mesh creating step of dividing a structure to be analyzed into a plurality of meshes, each including a plurality of nodes;
an analysis condition input step of inputting a constraint condition, a load condition and material properties of the structure;
a stiffness matrix creation step of creating a stiffness matrix based on the created meshes, the inputted constraint condition and the inputted material properties;
an ellipsoidal shape formulation step of solving a stiffness equation based on the inputted constraint condition and load condition and on the created stiffness matrix, obtaining displacements of all nodes for the load condition, and formulating equations of ellipsoidal shapes formed by the respective nodes based on the obtained displacements; and
a displacement calculation step of obtaining displacements of the respective nodes when an arbitrary load is applied to the structure based on the formulated equations of the ellipsoidal shapes.

3. A structure analysis program by the finite element method, wherein the program causes a computer to perform:
an ellipsoidal shape formulation step of, based on a characteristic that when a load is applied to a structure, an arbitrary point of the structure describes an ellipsoidal shape in accordance with a direction of the load, formulating an equation of an ellipsoidal shape formed by the arbitrary point of the structure when being displaced based on a constraint condition, a load condition and a stiffness matrix for the structure; and
a displacement calculation step of obtaining a displacement of the arbitrary point when an arbitrary load is applied to the structure based on the formulated equation of the ellipsoidal shape.

4. The structure analysis program by the finite element method according to claim 3, wherein the program causes a computer to perform:
a mesh creating step of dividing a structure to be analyzed into a plurality of meshes, each including a plurality of nodes;
an analysis condition input step of inputting a constraint condition, a load condition and material properties of the structure;
a stiffness matrix creation step of creating a stiffness matrix based on the created meshes, the inputted constraint condition and the inputted material properties;
the ellipsoidal shape formulation step to solve a stiffness equation based on the inputted constraint condition and load condition and on the created stiffness matrix, obtain displacements of all nodes for the load condition, and formulate equations of ellipsoidal shapes formed by the respective nodes based on the obtained displacements; and
the displacement calculation step to obtain displacements of the respective nodes when an arbitrary load is applied to the structure based on the formulated equations of the ellipsoidal shapes.
